(19) United States
(12) Patent Application Publication
(10) Pub. No.: US 2007/0035246 A1
(43) Pub. Date: Feb. 15, 2007

(54) Electrode structure and plasma display panel having the electrode structure

(76) Inventor: Jae-Young An, Suwon-si (KR)

Correspondence Address: Robert E. Bushnell, Suite 300, 1522 K Street, N.W., Washington, DC, 20005, US

(21) Appl. No.: 11/502,462

(22) Filed: Aug. 11, 2006

(30) Foreign Application Priority Data
Aug. 13, 2005 (KR) 10-2005-0074568

(51) Int. Cl. H01J 17/49

(52) U.S. Cl. 313/583

(57) ABSTRACT

An electrode structure is provided, the electrode structure prevents deterioration of a terminal electrode convergence line of an electrode terminal of a plasma display panel due to electric field concentration, and a plasma display panel having the electrode structure is also provided. The electrode structure may be constructed with a first electrode including a plurality of bus electrodes; a second electrode corresponding to the first electrode and including a plurality of bus electrodes; electrode terminal portions which are electrically connected to the first electrode and the second electrode, respectively, each of the electrode terminal portions including terminal electrode convergence lines which have rounded ends and are respectively electrically connected to all the bus electrodes included in the first electrode and the second electrodes, and terminal electrodes which extend as single lines connecting the terminal electrode convergence lines.

### CLAIM OF PRIORITY

This application makes reference to, incorporates the same herein, and claims all benefits accruing under 35 U.S.C.§ 119 from an application for STRUCTURE FOR TERMINAL PART OF ELECTRODE AND PLASMA DISPLAY PANEL COMPRISING THE SMAE earlier filed in the Korean Intellectual Property Office on 13 Aug. 2005 and there duly assigned Serial No. 10-2005-0074568.

### BACKGROUND OF THE INVENTION

1. Field of the Invention

The present invention relates to an electrode structure and a plasma display panel including the electrode structure, and more particularly, to an electrode structure that can prevent degradation of a terminal electrode convergence line of an electrode terminal caused by electric field concentration, and a plasma display panel including the electrode structure.

2. Description of the Related Art

A plasma display panel is a flat display panel that displays an image using gas discharge, and is popular due to its large screen size and strong advantages, such as extreme thinness, high resolution and large viewing angle.

A plasma display panel includes a first substrate and a second substrate opposite to and separated from the first substrate, discharge cells where discharges occur, and a plurality of electrodes to which voltage is applied. Discharges occur in discharge cells due to an alternating current (AC) or direct current (DC) voltage applied accross the electrodes, and ultra-violet light rays radiated from a discharge gas excites fluorescent substances to emit visible rays and produce an image.

The electrodes of the plasma display panel include address electrodes that generate address discharges and sustain electrodes that maintain the discharges. The electrodes are electrically connected to a driving circuit unit that generates electric signals for driving the plasma display panel.

The terminal portion of an electrode includes terminal electrode convergence lines that are electrically connected to the electrodes, a terminal electrode which extends as a single line connecting at least one or more terminal electrode convergence lines, and a terminal electrode junction portion connected to a signal transmission unit that transmits electric signals to the electrodes. In a conventional plasma display panel, the terminal electrode convergence lines have corners, resulting in electric field concentration. Heat is generated at portions of the convergence lines where the electric field is concentrated, thereby degrading the terminal electrode convergence lines.

The sustain electrodes include transparent electrodes which are typically made of indium tin oxide (ITO) or the like, to generate a discharge and increase visible light transmission. The sustain electrodes also include bus electrodes which are made of metal with low resistance, such as silver (Ag), to prevent a voltage sag and provide electric current to the transparent electrodes. However, the conventional sustain electrodes with a two-layer structure including the transparent electrode and the bus electrode have high manufacturing costs due to the transparent electrodes. It is also difficult to realize low-voltage driving because of the transparent electrodes with high resistance. Furthermore, the transparent electrodes and the bus electrodes must be aligned, reducing the manufacturing yield.

In an effort to solve the above problems, recent sustain electrodes include bus electrodes, but not transparent electrodes. Therefore, a technique for lowering a discharge firing voltage, maximizing a discharge space, and increasing an aperture ratio corresponding to visible light transmission has been developed.

Specifically, when a first electrode and a second electrode, which act together to generate a sustain discharge, are both bus electrodes and are disposed along barrier ribs which define discharge cells, the aperture ratio is increased to 100%, but the resulting distance between the bus electrodes is large, resulting in a high discharge firing voltage. On the other hand, if the distance between a pair of bus electrodes that generate a sustain discharge is decreased in order to reduce the discharge firing voltage, the discharge space is concomitantly narrowed. Alternatively, to lower the discharge firing voltage and maximize the discharge space, the distance between the bus electrodes may be decreased while increasing the width of the bus electrodes. In this case, however, the area of the discharge cell which is covered by the bus electrodes is increased, and thus the aperture ratio is undesirably, considerably reduced.

### SUMMARY OF THE INVENTION

It is therefore, an object of the present invention to provide an improved plasma display panel.

It is another object to provide an electrode structure in which a terminal electrode convergence line has rounded ends such that deterioration of the terminal electrode convergence line due to electric field concentration is prevented.

It is still another object to provide a plasma display panel in which sustain electrodes include bus electrodes but not transparent electrodes, and thus manufacturing costs of the plasma display panel are reduced, a voltage sag is prevented due to low resistance of electrodes, a discharge firing voltage is lowered, a discharge space is maximized, and an aperture ratio is increased.

According to one embodiment of the present invention, an electrode structure of a plasma display panel is provided, the electrode structure with a first electrode including a plurality of bus electrodes; a second electrode corresponding to the first electrode and including a plurality of bus electrodes; and electrode terminal portions which are electrically connected to the first electrode and the second electrode, respectively, each of the electrode terminal portions may be constructed with terminal electrode convergence lines which have rounded ends and are respectively electrically connected to all the bus electrodes included in the first electrode and the second electrodes; and terminal electrodes which extend as a single line formed by connecting the terminal electrode convergence lines.

As described above, since each of the electrode terminal portions has a terminal electrode convergence line having rounded ends, deterioration of the terminal electrode convergence line due to electric field concentration is prevented.

The first electrode or the second electrode may further use short bars to interconnect the plurality of bus electrodes included in the first electrode or the second electrode. However, the present invention may not be limited to this arrangement.

The second electrode may extend in a direction intersecting the direction of extension of the first electrode. Alternatively, the electrode structure may use an address electrode which extends in a direction intersecting the direction of extension of the first electrode and the second electrode, wherein the first electrode and the second electrode extend parallel to each other. Furthermore, the terminal electrode may be electrically connected to a signal transmission unit that transmits an electrical signal to the first electrode or the second electrode.

According to another embodiment of the present invention, a plasma display panel is provided, the plasma display panel including: a first substrate; a second substrate separated from and parallel to the first substrate; barrier ribs which are interposed between the first substrate and the second substrate and define separated discharge cells where a gas discharge occurs; a plurality of sustain electrode pairs which are interposed between the first substrate and the second substrate, cause a gas discharge, and include a first electrode and a second electrode, each of the first and second electrodes including a plurality of bus electrodes; electrode terminal portions which are electrically connected to the first electrode and the second electrode, respectively, each of the electrode terminal portions including: terminal electrode convergence lines which have rounded ends and are respectively electrically connected to the bus electrodes included in the first electrodes and the second electrodes; and terminal electrodes which extend as a single line formed by connecting the terminal electrode convergence lines. The plasma display panel may also use a fluorescent layer formed inside each of the discharge cells and a discharge gas injected into the discharge cells.

Herein, the first electrode or the second electrode may use short bars that interconnect the plurality bus electrodes included in the first electrode or the second electrode. The present invention, however, should not be limited to this arrangement. The first electrode or the second electrode may include a short bar that interconnects the plurality bus electrodes included in the first electrode or the second electrode, however, the present invention should not be limited to this arrangement, either.

All of the bus electrodes included in each of the sustain electrode pairs may extend in a direction intersecting the same discharge cell. The present invention, however, should not be limited to this arrangement. The sustain electrode pairs may be disposed on the first substrate. However, the present invention may not be limited to this arrangement. That is, some of the bus electrodes may, in an alternative embodiment, be disposed outside of the discharge cell, for example, on barrier ribs or in a non-discharge cell.

The second electrodes may extend in a direction intersecting the direction of extension of the first electrodes. On the other hand, The plasma display panel may further include an address electrode which extends in a direction intersecting the direction of extension of the first electrode and the second electrode, wherein the first electrode and the second electrode extend parallel to each other. The address electrode may be disposed on the second substrate. The terminal electrode may be electrically connected to a signal transmission unit that transmits an electrical signal to the first electrode or the second electrode.

The present invention also provides a plasma display panel in which sustain electrodes include bus electrodes but not transparent electrodes, and thus manufacturing costs of the plasma display panel are reduced, a voltage sag is prevented due to low resistance of electrodes, a discharge firing voltage is lowered, a discharge space is maximized, and an aperture ratio is increased.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of a plasma display panel constructed as an embodiment of the principles of the present invention;

FIG. 2 is an exploded partial perspective view of a portion D shown in FIG. 1;

FIG. 3 is a plan view of electrodes and electrode terminal portions illustrated in FIG. 2;

FIG. 4 is a cross-sectional view taken along line IV-IV in FIG. 2; and

FIG. 5 is a cross-sectional view taken along line V-V in FIG. 2.

### DETAILED DESCRIPTION OF THE INVENTION

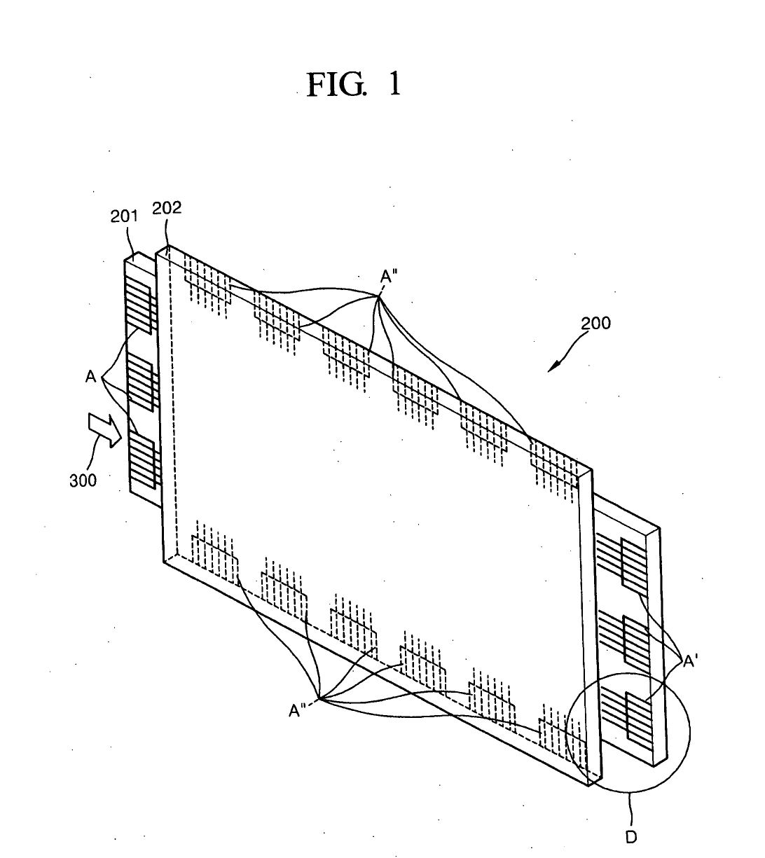

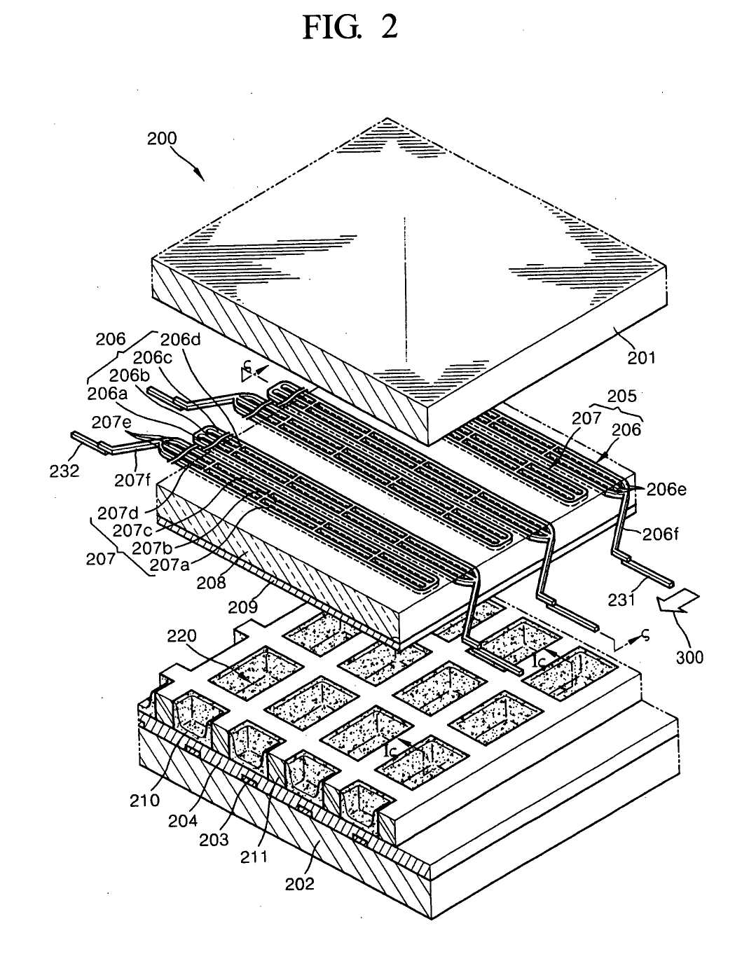

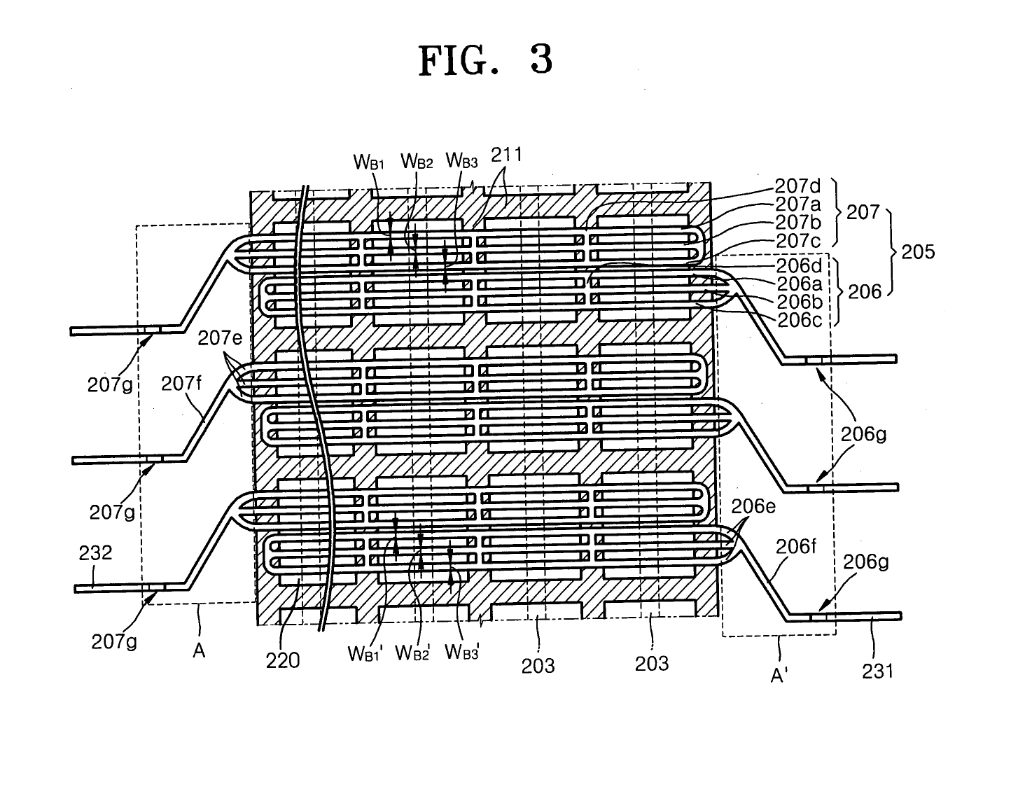

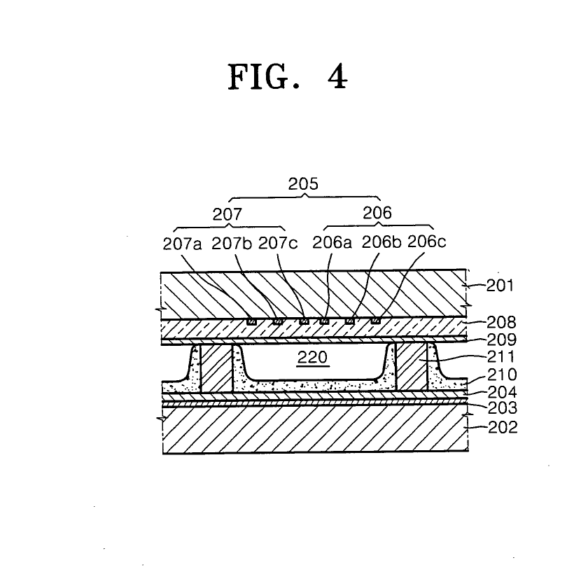

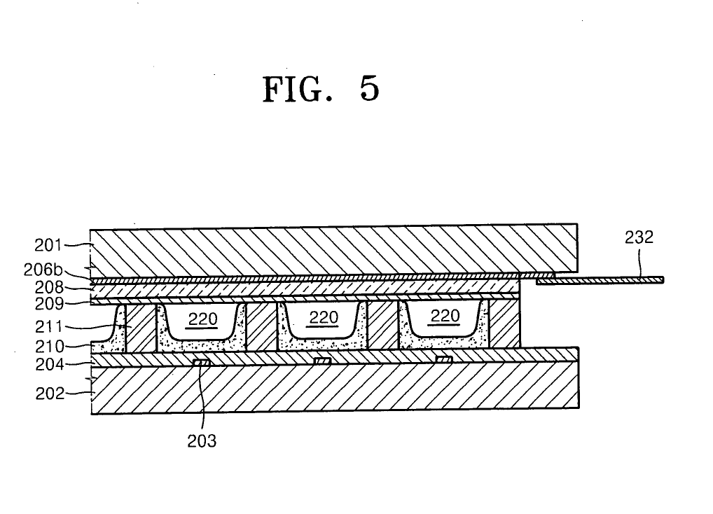

FIG. 1 is a perspective view of a plasma display panel 200 according to an embodiment of the present invention. FIG. 2 is an exploded partial perspective view of a portion D of FIG. 1, and FIG. 3 is a plan view of sustain electrodes 205, terminal electrodes 206f and 207f, and electrode terminal portions A and A′ illustrated in FIG. 2. FIG. 4 is a cross-sectional view taken along line IV-IV of FIG. 2, and FIG. 5 is a cross-sectional view taken along line V-V in FIG. 2.

Referring to FIGS. 1 through 5, plasma display panel 200 includes a pair of substrates 201 and 202, barrier ribs 211, a plurality of sustain electrode pairs 205, electrode terminal portions A and A′, terminal electrode convergence lines 206e and 207e, terminal electrodes 206f and 207f, fluorescent layers 210 and a discharge gas 300.

The pair of substrates 201 and 202 includes a first substrate 201 and a second substrate 202 disposed at a predetermined distance from each other and face each other. First substrate 201 is formed of glass such that visible light rays can permeate first substrate 201. In the present embodiment, since first substrate 201 is made of glass, visible light generated in fluorescent layer 210 passes through first substrate 201 and advances to the outside. Second substrate 202 may also be formed of glass such that visible rays can pass through second substrate 202 and advance to the outside.

Barrier ribs 211 define a plurality of discharge cells 220 between first and second substrates 201 and 202. Moreover, since the size of first and second substrates 201 and 202 is larger than the size of barrier ribs 211, first and second substrates 201 and 202 sufficiently cover discharge cells 220 defined by barrier ribs 211, and signal transmission units 231 and 232 can be easily installed in the portions of first and second substrate 201 and 202 where barrier ribs 211 are not disposed.

In the present embodiment, the cross-section of each discharge cell 220 partitioned by barrier ribs 211 is rectangular, but the present invention is not limited to this shape, and the cross-sections of discharge cells 220 can have a variety of shapes such as polygonal, for example triangular or pentagonal, circular or oval.

Barrier ribs 211 are interposed between first substrate 201 and second substrate 202, and can be made of a dielectric layer.

Each of sustain electrode pairs 205 includes a first electrode 206 and a second electrode 207 disposed on first substrate 201. However, the present invention is not limited to this arrangement, and sustain electrode pairs 205 may be disposed inside the barrier ribs 211, or on the second substrate 202. A first dielectric layer 208 which is disposed on first substrate 201 for covering sustain electrode pairs 205 prevents the adjacent first electrode 206 and second electrode 207 from being directly charged during discharge and prevents damage to sustain electrode pairs 205 by preventing the charged particles from directly colliding sustain electrode pairs 205. When a voltage is applied between each of sustain electrode pairs 205, a seed electron is generated and accelerated by an electric field between a corresponding sustain electrode pair 205. An accelerated electron collides with a neutral particle in a discharge gas 300, which generates an electron and an ion. The continuous collision of accelerated electrons causes an avalanche gas discharge. The produced ions collide with the electrode (a dielectric layer or a protective layer in case of an AC type plasma display panel) and generate secondary electrons. The accelerated secondary electrons collide with neutral particles and generate electrons and ions. The continuous collision of the accelerated secondary electrons causes another avalanche gas discharge. The produced ions and electrons are attracted by sustain electrodes 205, thereby wall charges can accumulate in first dielectric layer 208. First dielectric layer 208 may be formed of PbO, B₂O₃, or SiO₂.

A protective layer 209 formed of magnesium oxide (MgO) or the like may be disposed on first dielectric layer 208. Protective layer 209 prevents damage to sustain electrode pairs 205 by the sputtering of plasma particles, and lowers a discharge voltage by discharging a large number of secondary electrons.

First electrode 206 is a common electrode and generates a sustain discharge with second electrode 207. First electrode 206 includes three bus electrodes 206a, 206b, and 206c in the present embodiment, but the present invention is not limited to this number. First electrode 206 may include two bus electrodes or four or more bus electrodes.

Second electrode 207 is a scan electrode. Second electrode 207 and an address electrode 203, which will be described later, produce an address discharge for selecting a discharge cell 220 in which a gas discharge occurs. And second electrode 207 and first electrode 206 produce a sustain discharge in a sustain discharge period. Second electrode 207 includes three bus electrodes 207a, 207b, and 207c in the present embodiment, but the present invention is not limited to this number. Second electrode 207 may include two bus electrodes or four or more bus electrodes.

Bus electrodes 206a, 206b, 206c, 207a, 207b, and 207c are made of a metal, such as silver (Ag), platinum (Pt), palladium (Pd), nickel (Ni), copper (Cu) or the like, and/or a conductive ceramic material such as indium doped tin oxide (ITO), antimony doped tin oxide (ATO), carbon nano tubes (CNT) or the like. Since costly transparent electrodes with high resistance are not used, manufacturing costs are reduced, and the resistance of the electrodes is lowered, and thus a voltage sag is prevented.

Bus electrodes 206a, 206b, and 206c, and 207a, 207b, and 207c are all narrow in width. First and second electrodes 206 and 207 are parallel to each other. A discharge is initiated between bus electrode 206a of first electrode 206 and bus electrode 207c of second electrode 207 which are closest to each other among the plurality of bus electrodes 206a, 206b, and 206c, and 207a, 207b, and 207c forming first and second electrodes 206 and 207, respectively, and thus a discharge firing voltage can be reduced. The discharge gradually expands to bus electrodes 206b and 206c of first electrode 206 and bus electrodes 207b and 207c of second electrode 207, and thus the discharge space can be maximized.

Widths WB1′, WB2′, and WB3′ and WB1, WB2, and WB3 of bus electrodes 206a,206b, and 206c, and 207a, 207b, and 207c forming the first electrode 206 and the second electrode 207, respectively, are small, and thus an aperture ratio is increased, thereby increasing visible light transmission and enhancing luminance. More specifically, using conventional manufacturing techniques, the total of widths WB1′, WB2′, and WB3′ of bus electrodes 206a, 206b, and 206c and the total of widths WB1, WB2, and WB3 of bus electrode 207a, 207b, and 207c that form first electrode 206 and second electrode 207, respectively, may be less than 150 μm, but the present invention is not limited to this dimension.

Electrode terminal portions A and A′ are predetermined regions where first electrodes 206 and second electrodes 207 are electrically connected to signal transmission units 231 and 232. Signal transmission units 231 and 232 transmit electrical signals to first electrodes 206 and second electrodes 207, and may be a tape carrier package (TCP), a chip on film (COF), or a flexible printed circuit (FPC).

Electrode terminal portions A and A′ include terminal electrode convergence lines 206e and 207e, which are end portions of bus electrodes 206a, 206b, and 206c, forming first electrode 206 and bus electrodes 207a, 207b, and 207c forming the second electrode 207, respectively. Terminal electrode convergence lines 206a and 207e are respectively electrically connected to terminal electrodes 206f and 207f, which will be described later.

Terminal electrode convergence lines 206e and 207e may have a rounded end instead of corners, and may be formed as a thick film using a photosensitive paste or a thin film using a sputtering method or evaporation method. Accordingly, the conventional problem of a great amount of heat being generated due to electric field concentration resulting in the deterioration of terminal electrode convergence lines 206e and 207e can be prevented. The electric field concentration is the concentration of an electric field around the corners of a conductor placed in the electric field. When a partial discharge occurs in the portion where the electric field is concentrated, that portion begins to deteriorate.

Electrode terminal portions A and A′ include terminal electrodes 206f and 207f, respectively. Terminal electrodes 206f and 207f respectively extend as single lines from terminal electrode convergence lines 206e and 207e. Terminal electrodes 206f and 207f are fabricated as a thick film using a photosensitive paste, or a thin film using a sputtering or evaporation process. Accordingly, first electrodes 206 including bus electrodes 206a, 206b, and 206c or second electrodes 207 including bus electrodes 207a, 207b, and 207c can be electrically connected to signal transmission unit 231 of 232 of a limited size in a terminal electrode connection portion 206g or 207g via terminal electrode 206f or 207f.

Signal transmission units 231 and 232 contact surfaces of terminal electrodes 206f and 207f that do not face first substrate 201, but the present invention is not limited to this arrangement. Signal transmission units 231 and 232 may be disposed at different positions.

First electrode 206 and second electrode 207 may each further include short bars 206d and 207d that interconnect bus electrodes 206a, 206b, and 206c and bus electrodes 207a, 207b, and 207c, respectively. Therefore, even when some of the plurality of bus electrodes 206a, 206b, and 206c, and 207a, 207b, and 207c forming first electrode 206 and second electrode 207 break, short bars 206d and 207d can compensate for such damage. But the present invention is not limited to this arrangement. Short bars 206d and 207d are not necessarily included in first and second electrodes 206 and 207, respectively. Furthermore, short bars 206d and 207d are arranged along the barrier ribs 211 outside discharge cells 220 such that discharge cells 220 are not screened by short bars 206d and 207d. Hence, short bars 206d and 207d do not decrease the aperture ratio. Although short bars 206d and 207d are interposed between all bus electrodes 206a, 206b, and 206c, and 207a, 207b, and 207c included in each of first and second electrodes 206 and 207 in drawings, the present invention is not limited to this arrangement. Short bars 206d and 207d may be interposed between some of bus electrodes 206a, 206b, and 206c, and 207a, 207b, and 207c. Moreover, short bars 206d and 207d are disposed on all of the barrier ribs 211 that are parallel to each other in the drawings, but the present invention is not limited to this arrangement. Short bars 206d and 207d may be placed on every two or more barrier ribs 211.

Also, short bars 206d and 207d may be arranged in a regular or irregular pattern.

Bus electrodes 206a, 206b, and 206c, and 207a, 207b, and 207c included in each sustain electrode pair 205 including first electrode 206 and second electrode 207 may be parallel to each other and disposed corresponding to the same discharge cell 220. As shown in FIG. 3, the plurality of bus electrodes 206a, 206b, and 206c forming first electrode 206 and the plurality of bus electrodes 207a, 207b, and 207c forming second electrode 207 are disposed corresponding to a predetermined discharge cell 220. But the present invention is not limited to this arrangement. Second electrodes 207 may be formed so as to cross first electrodes 206. In this case, since a discharge cell 220 in which a discharge is initiated can be selected by applying a voltage between first and second electrodes 206 and 207, address electrode 203, which will be described later, is not necessary.

Alternatively, first electrodes 206 and second electrodes 207 may extend parallel to each other, and address electrodes 203, which are formed so as to intersect the first and second electrodes 206 and 207, may be further provided. Discharge cell 220 where a discharge occurs can be selected by selecting appropriate second electrode 207 among first and second electrodes 206 and 207 and appropriate address electrode 203. In this case, address electrodes 203 may be disposed on second substrate 202, but the present invention is not limited to this arrangement. Address electrodes 203 may be arranged in various ways, for example, inside barrier ribs 211.

A second dielectric layer 204 may cover address electrodes 203. Second dielectric layer 204 is formed of a dielectric which can prevent damage to address electrodes 203 by preventing positive ions or electrons from colliding with address electrodes 203 and induce electrons. The dielectric may be PbO, B₂O₃, SiO₂, or the like.

Fluorescent layer 210 is formed on a bottom surface of discharge cell 220 and sides of barrier rib 221, but the present invention is not limited to this arrangement. Fluorescent layer 210 may be formed in any portion of discharge cell 220, such as the top surface of discharge cell 220. Fluorescent layer 210 includes a component that receives ultra-violet light and generates visible light. A red fluorescent layer formed in a red luminous discharge cell includes a fluorescent material such as Y(V,P)0₄:Eu, a green fluorescent layer formed in a green luminous discharge cell includes a green fluorescent material such as Zn₂SiO₄:Mn, and a blue fluorescent layer formed in a blue luminous discharge cell includes a fluorescent material such as BAM:Eu. Discharge cells 220 defined by first substrate 201, second substrate 202 and barrier ribs 211 are injected with a discharge gas 300 such as mixture gas of Ne, Xe, or the like.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electrode structure of a plasma display panel, the electrode structure comprising:
a first electrode including a plurality of bus electrodes;
a second electrode corresponding to the first electrode and including a plurality of bus electrodes; and
electrode terminal portions which are electrically connected to the first electrode and the second electrode, respectively, each of the electrode terminal portions comprising:
terminal electrode convergence lines which have rounded ends and are respectively electrically connected to all the bus electrodes included in the first electrode and the second electrodes; and
terminal electrodes which are formed as single lines connecting the terminal electrode convergence lines.

2. The structure of claim 1, in which the first electrode or the second electrode further includes short bars that interconnect the plurality bus electrodes included in the first electrode or the second electrode.

3. The structure of claim 1, in which the second electrode extends in a direction intersecting the direction of extension of the first electrode.

4. The structure of claim 1, further comprising an address electrode which extends in a direction intersecting the direction of extension of the first electrode and the second electrode, wherein the first electrode and the second electrode extend parallel to each other.

5. The structure of claim 1, in which the terminal electrode is electrically connected to a signal transmission unit that transmits an electrical signal to the first electrode or the second electrode.

6. A plasma display panel, comprising:
a first substrate;
a second substrate separated from and parallel to the first substrate;
barrier ribs which are interposed between the first substrate and the second substrate and define partition discharge cells where gas discharges occur;
a plurality of sustain electrode pairs which are interposed between the first substrate and the second substrate, cause a gas discharge, and include a first electrode and a second electrode, each of the first and second electrodes including a plurality of bus electrodes;
electrode terminal portions which are electrically connected to the first electrode and the second electrode, respectively, each of the electrode terminal portions comprising:
terminal electrode convergence lines which have rounded ends and are respectively electrically connected to the bus electrodes included in the first electrodes and the second electrodes; and
terminal electrodes which extend as a single line formed by connecting the terminal electrode convergence lines;
a fluorescent layer formed in each of the discharge cells; and
a discharge gas injected into the discharge cells.

7. The plasma display panel of claim 6, in which the first electrode or the second electrode further comprises a short bar that interconnects the plurality of bus electrodes included in the first electrode or the second electrode.

8. The plasma display panel of claim 7, in which the position of the short bar corresponds to the barrier ribs extending perpendicular to the bus electrodes.

9. The plasma display panel of claim 6, in which all of the bus electrodes included in each of the sustain electrode pairs extend in a direction that intersect the same discharge cell.

10. The plasma display panel of claim 6, in which the sustain electrode pairs are disposed on the first substrate.

11. The plasma display panel of claim 6, in which the second electrodes extends in a direction intersecting the direction of extension of the first electrodes.

12. The plasma display panel of claim 6, further comprising an address electrode which extends in a direction intersecting the direction of extension of the first electrode and the second electrode, wherein the first electrode and the second electrode extend parallel to each other.

13. The plasma display panel of claim 12, in which the address electrode is disposed on the second substrate.

14. The plasma display panel of claim 6, in which the terminal electrode is electrically connected to a signal transmission unit that transmits an electrical signal to the first electrode or the second electrode.
